(19) United States
(12) Patent Application Publication
(10) Pub. No.: US 2003/0074506 A1
(43) Pub. Date: Apr. 17, 2003

(54) Extending processors from two-way to four-way configuration

(75) Inventors: Rachid Kadri, Houston, TX (US); Lam Ngo, Raleigh, NC (US); Pivithuru Shaluka Perera, Raleigh, NC (US); Mohamad Hassan Tawil, Cary, NC (US)

Correspondence Address: BRACEWELL & PATTERSON, L.L.P., Intellectual Property Law, P.O. box 969, AUSTIN, TX, 78767-0969, US

(73) Assignee: International Business Machines Corporation, Armonk, NY

(21) Appl. No.: 09/978,512

(22) Filed: Oct. 16, 2001

(51) Int. Cl. G06F 13/362

(52) U.S. Cl. 710/113

(57) ABSTRACT

A computer system extends the capacity of processors with limited external arbitration and operable only for two-way or dual mode operation. The two-way processors operate on a system bus in a four-way configuration at comparable performance levels to high end, four-way processors. A bus agent or arbiter allows the system to use two-way configured processors to operate with the performance of those specifically configured for four-way node operation.

### BACKGROUND OF THE INVENTION

1. Technical Field

The present invention relates in general to data processing systems using multiple processors operating on a common bus. More specifically, the present invention provides a data processing system with processors having external arbitration lines for operation only in a two-way configuration, but made operable according to the present invention for sharing a common bus in a four-way configuration.

2. Description of the Related Art

Certain vendors of processors offer several types of otherwise similar processor models, depending on the expected end user. Certain types of these processors have a number of desirable performance features or characteristics, but are limited in their ability to work in a cooperative relation beyond limited situations. So far as is known, these low end processors have smaller internal cache than other processor models, but offer a higher core frequency and a higher front side bus frequency. However, these processors are provided with only two external arbitration lines. For example, Intel Corporation offers processors known as Intel®DP processors for operation in a two-way configuration with two such processors adapted to serve on a common bus. These processors are thus at present primarily for individual workstations and low end, less heavy utilization market.

Other types of processors intended for high end, higher service demand users, such as the QP processor from Intel Corporation are significantly more costly than processors intended for the low end workstation and less strenuous usage market. The low end or two-way processors, so far as can be ascertained, provide the same internal operations and logic as others intended for higher levels of bus sharing. However, as noted above, the otherwise suitable two-way processors are limited in the number of external arbitration lines. Re-design of these two-way processors to include additional lines would involve significant effort and likely increase their cost beyond that of the four-way processors already available. It would thus be desirable to utilize the processing capabilities presently available in two-way processors by providing them in four-way configurations.

### SUMMARY OF THE INVENTION

It is an object of the present invention to provide a data processing system and method of extending the capacity of processors limited in arbitration levels to higher levels of configurations on a common bus.

It is a further object of the present invention to provide a data processing system composed of data processing nodes with processors which are individually limited in their number of external lines to two, yet can have their capacity extended to function in a four-way configuration over a common bus or local interconnect.

It is yet another object of the present invention to provide a method of operating a data processing node in a four-way configuration over a local interconnect of processors limited to two external arbitration lines.

In accordance with the present invention, data processing nodes operable, either alone or as part of a larger system, are composed of four processors operating off a common local interconnect. Each of the four processors is connected to the local interconnect and has only two external arbitration lines. An arbiter is connected to each of the two external arbitration lines of each of the four processors and arbitrates on behalf of the four processors for access to the local interconnect.

The foregoing and other objects and advantages of the present invention will be apparent to those skilled in the art, in view of the following detailed description of the preferred embodiment of the present invention, taken in conjunction with the appended claims and the accompanying drawings.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 depicts a prior art system of processors operating in a two-way configuration over a local interconnect;

FIG. 2 depicts a data processing system according to the present invention with nodes having processors like those of FIG. 1 operating in a four-way configuration over a local interconnect; and

FIG. 3 is a state diagram depicting the method of arbitration according to the present invention among the processors depicted in FIG. 2.

### DETAILED DESCRIPTION OF THE PREFERRED EMBODIMENT

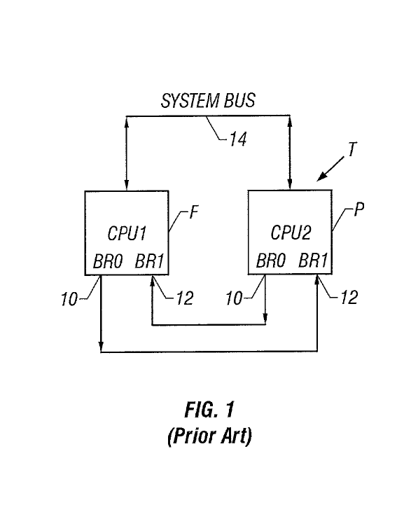

With reference now to the figures and in particular with reference to FIG. 1, there is depicted a conventional, prior art two-way configuration T of a set of two commercially available processors P, such as the Intel®DP processor, designed for two-way multiprocessor or MP systems only. The individual processors P are of like construction and function in their data processing and are identified in general by a like reference identifier P. Each of the processors P have only two external arbitration lines, available on each processor P at its respective BRO pin or terminal 10 and a BR1 pin or terminal 12. The processors operate off a common bus 14 and are interconnected for two-way multiprocessor operation by having their BRO pin 10 of the processor connected to the BR1 pin 12 of the other processor.

Each of the two processors P of FIG. 1 provides at its respective BRO pin 10 at appropriate times a processor arbitration bus signal in the conventional manner, indicating that the particular processor P wants control or ownership of the system bus 14. Assertion of the bus request signal seeks control by the asserting processor of the system bus 14. When the requesting processor is granted control of the system bus 14, it becomes what is known as a priority processor. Control of the system bus 14 once granted is maintained by the priority processor until the activity causing the bus request from the priority processor has ben completed.

Each of the processors is also connected at its BR1 pin 12 to the BR0 pin 10 from the other processor P shown in FIG. 1. When the BR1 pin 12 of a processor P receives a bus request signal asserted from the BR0 pin 10 of the other processor, the receiving processor P maintains an asserted state and stops issuing bus requests at its BR0 pin 10 on its own behalf. The requesting processor P maintains the receiving processor in the asserted state until all activity giving rise to the bus request has been completed. At such a time, the signal from BR0 pin 10 is deasserted and the system bus 14 is released.

The processors P, however, have similar internal configuration, operation and logic to that available from processors intended for high end or four-way processing. Further, the processors P have certain desirable features, such as a higher core frequency, higher front side frequency and therefore a faster memory subsystem. However, as noted, the processors P are designed for only two-way multiprocessor systems because of their having only two external arbitration lines. With the present invention, however, four such processors P are configured into a node N, as will be set forth, in a manner permitting high end, four way multiprocessor configurations.

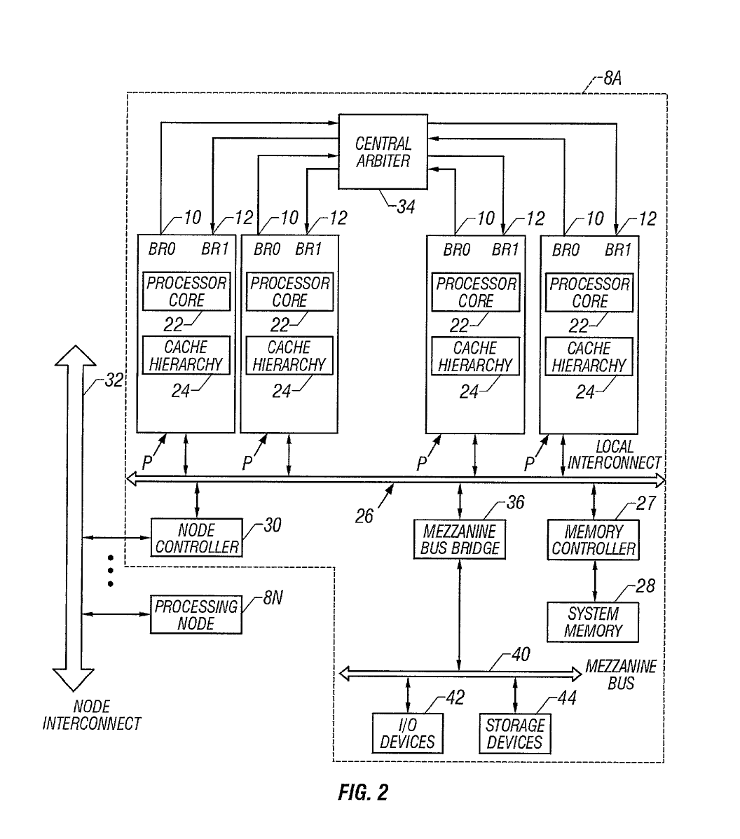

With reference now to the figures and in particular with reference to FIG. 2, there is depicted an illustrative embodiment of a NUMA computer system composed of multiple processing nodes 8A-8N of four-way configuration of processors P which each have only two external arbitration lines in accordance with the present invention. The depicted embodiment can be realized, for example, as a workstation, server, or mainframe computer. As illustrated, NUMA computer system 16 includes a number (N≧2) of processing nodes 8A-8N, which are interconnected by node interconnect 32. Processing nodes 8A-8N each include four processors P, a local interconnect 26, and a system memory 28 that is accessed via a memory controller 27. The four processors P are commercially available two-way processors as noted, having only two external arbitration lines available at their respective BRO pin 10 and BR1 pin 12. A suitable such processor for each processor P may be an Intel®DP processor available from Intel Corporation of San Jose, Calif. In addition to the registers, instruction flow logic and execution units utilized to execute program instructions, which are generally designated as processor core 22, each of processors P also includes an on-chip cache hierarchy that is utilized to stage data to the associated processor core 22 from system memories 28. Each cache hierarchy 24 includes at least one level of cache and may include, for example, a level one (L1) cache and a level two (L2) cache having storage capacities of between 8-32 kilobytes (kB) and 1-16 megabytes (MB), respectively. As is conventional, such caches are managed by a cache controller that, among other things, implements a selected cache line replacement scheme and a coherency protocol. In the present disclosure, each processor P and its associated cache hierarchy 24 is considered to be a single snooper.

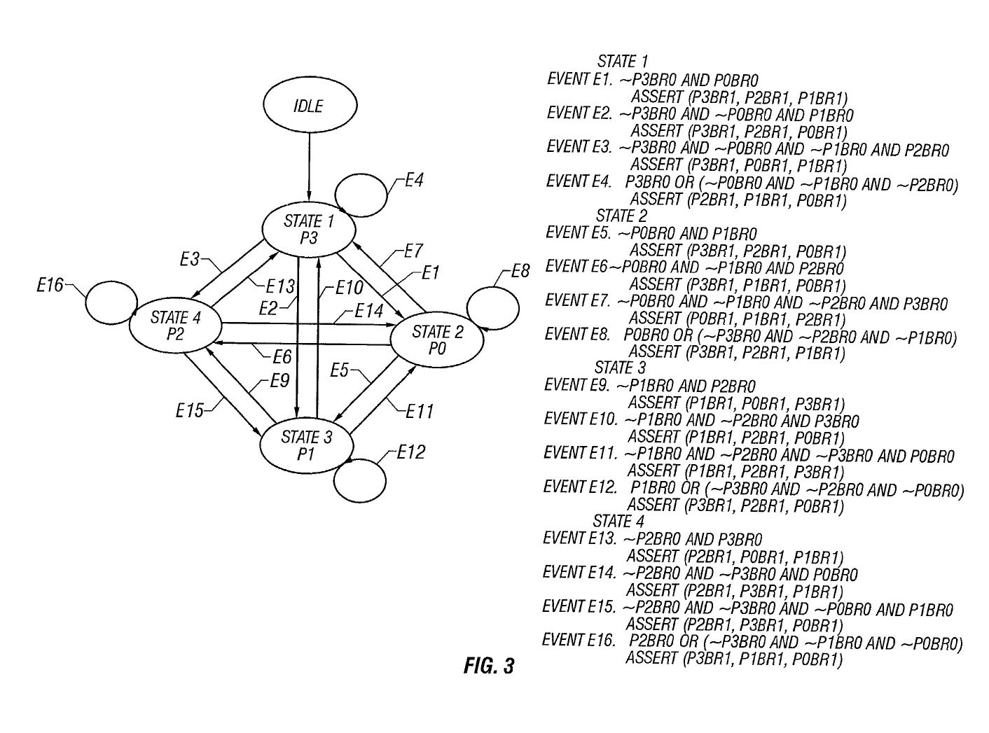

Each of processing nodes 8a-8n further includes a respective node controller 30 coupled between local interconnect 26 and node interconnect 32. Each node controller 30 serves as a local agent for remote processing nodes P by performing at least two functions. First, each node controller 30 snoops the associated local interconnect 26 and facilitates the transmission of local communication transactions (e.g., read-type requests) to remote processing nodes P. Second, each node controller 30 snoops communication transactions on node interconnect 32 and masters relevant communication transactions on the associated local interconnect 26. Communication on each local interconnect 26 is controlled by an arbiter 34. Arbiter 34 regulates access to local interconnect 26 based on bus request signals generated by the four processors P and furnished over their respective two external arbitration lines at BRO pin 10 and BR1 pin 12. Arbitration operations in the four-way configuration are shown in FIG. 3 of the drawing and will be described in more detail below. The arbiter 34 also may, if desired, compile coherency responses for snooped communication transactions on local interconnects 26.

Local interconnect 26 is coupled, via mezzanine bus bridge 36, to a mezzanine bus 40, which may be implemented as a Peripheral Component Interconnect (PCI) local bus, for example. Mezzanine bus bridge 36 provides both a low latency path through which processors P may directly access devices among I/O devices 42 and storage devices 44 that are mapped to bus memory and/or I/O address spaces and a high bandwidth path through which I/O devices 42 and storage devices 44 may access system memory 28. I/O devices 42 may include, for example, a display device, a keyboard, a graphical pointer, and serial and parallel ports for connection to external networks or attached devices. Storage devices 44, on the other hand, may include optical or magnetic disks that provide non-volatile storage for operating system and application software.

Referring now to FIG. 3, a state machine M of the arbitration method employed in the arbiter 34 according to the present invention between the four processors P of FIG. 2 according to the present invention is shown. In order to facilitate explanation of their operation according to FIG. 3, the four processors are identified as P0, P1, P2 and P3, respectively, in FIG. 3. The present invention arbitrates in arbiter or arbitator 34 on behalf of each of these four processors P for access to and control or ownership of the local interconnect or bus 26. Those skilled in the art will recognize that the state machine M may be implemented b y suitable logic within the arbitrator 34.

The following nomenclature convention applies to describe the arbitration operation signals an operations depicted in FIG. 3.

˜—indicates an inverted or NOT state at a particular pin.

PnBR0—indicate that a processor Pn is requesting at its terminal BR0 ownership or control of the local interconnect 26.

ASSERT PnBR1—indicates that a processor Pn is inhibited from asserting bus requests on its own behalf to the local interconnect 26.

As is evident in FIG. 3, the arbiter 34 startsinan IDLE state and on start-up of node 8A, its software BIOS verifies that four processors are installed on bus 26, also initializing each of the processors P and assigning unique code identifiers, as symbolized in the drawings by reference identifiers P0, P1, P2 and P3, to the four processors. Processor P3 is set to be the primary processor for the purposes of the present invention.

Operation of the arbiter 34 then proceeds from the IDLE state to State 1, where the arbiter 34 allows processor P3 ownership of the bus 26. Processor P3 retains control of the bus 26 until an event E1 occurs, namely that processor P0 issues a request at its BR0 terminal 10 for ownership of the local interconnect or bus 26. In such an event, the arbiter 34 transitions from State 1 to State 2 and processor P0 acquires control of the bus 26. The processors P1, P2 and P3 are at this time also inhibited from indicating bus requests until processor P0 completes activities of its current bus request.

An event E2 may occur while arbiter 34 is in State 1 prior to event E1. During event E2, processor P1 issues a request at its BR0 terminal 10 for ownership of the bus 26 at a time when neither of processors P3 or P0 is making such a request. In that case, the arbiter 34 transitions from State 1 to State 3 and processor P1 acquires control of bus 26. The processors P0, P2 and P3 are also inhibited from indicating bus requests until processor P1 completes the activities under its then present bus request.

An event E3 may occur in State 1 prior to either event E1 or event E2, if processor P2 issues a bus request with arbiter 34 in State 1 and processors P3, P0 and P1 are not making such a request at their respective BR0 terminals 10. In such a situation, the arbiter 34 transitions from State 1 to State 4 and processor P2 acquires control of the bus 26. Processors P3, P0 and P1 are inhibited from indicating bus requests until processor P2 relinquishes control of bus 26 by ceasing to indicate its bus request at its BR0 terminal 10.

Event E4 occurs with arbiter 34 in State 1 if processor P3 issues a bus request or when none of the other processors P0, P1 or P2 is making a bus request at its BR0 terminal 10. At the occurrence of event E4 for either case, arbiter 34 remains in State 1 until either event E1, event E2 or event E3 occurs.

In State 2, arbiter 34 grants processor P0 ownership of the local interconnect or bus 26 until an event E5 occurs. In event E5, processor P1 issues a bus request when processor P0 is not making such a request. Arbiter 34 then transitions from State 2 to State 3, and control of local interconnect 26 is granted to processor P1. Processors P0, P2 and P3 are also inhibited from indicating bus requests until processor P1 completes actions as a result of its bus request.

Event E6 occurs with arbiter 34 in State 2 in when processor P2 issues a request for ownership of the bus 26 with arbiter in State 2 when neither of processors P0 or P1 is making such a request. In that case, the arbiter 34 transitions from State 2 to State 4, and processor P2 acquires control of local interconnect 26. Processors P0, P1 and P3 are also inhibited from indicating bus requests until processor P2 completes action requires as a result of its bus request.

Event E7 with arbiter 34 in State 2 occurs if processor P3 requests control of local interconnect 26 while arbiter is in State 2 and when none of the other processors is making a similar request. In such a case, arbiter 34 transitions from State 2 to State 1 and processors P0, P1 and P2 are inhibited from indicating bus requests until processor P3 relinquishes control of the bus 26 in response to a request from one of the other processors, either P0, P1 or P2.

Event E8 in State 2 occurs if processor P0 is making a bus request signal or if none of the other processors is making a similar request at its BR0 terminal 10. On occurrence of event E8, arbiter 34 remains in State 2 until one of events E5, E6 or E7 occurs.

Event E9 in State 3 occurs when processor P2 issues a bus ownership request at its BR0 terminal 10 for control of local interconnect 26 when processor P1 is not making such a request. In that case, the arbiter 34 transits from State 3 to State 4 and processors P0, P1 and P3 are inhibited from indicating bus requests until processor P2 completes its activities which gave rise to the bus request.

Event E10 during State 3 occurs if processor P3 issues a bus ownership request at its BR0 terminal 10 and neither of processors P1 or P2 are making a similar request from their respective BR0 terminals 10. Arbiter 34 transitions from State 3 to State 1 and processors P0, P1 and P2 do not assert bus requests until processor P3 transitions from State 1.

Event E11 occurs in State 3 if processor P0 issues a bus ownership request at its BR0 terminal 10 for control of local interconnect 26 when none of processors P1, P2 and P3 are making such a request. Arbiter 34 transitions to State 2 and processors P1, P2 and P3 are inhibited from indicating bus requests until processor P0 exits from State 2.

Event E12 in State 3 occurs if processor P1 is making a bus request signal at its BR0 terminal 10 or if none of the other processors is making such a request. In such a situation, arbiter 34 remains in State 3 until event E9, E10 or E11 should occur.

In State 4, an event E13 occurs when processor P3 issues a bus request signal at its BR0 terminal 10 and processor P2 is not making such a request at its BR0 terminal 10. Arbiter 34 then transitions from State 4 to State 1 and processors P0, P1 and P2 are inhibited from indicating bus requests until processor P3 transitions from State 1 in one of events E1, E2 or E3.

An event E14 in State 4 occurs if processor P0 issues a bus ownership signal at its BR0 terminal 10 and neither processor P2 nor P3 is making such a request. Arbiter 34 transitions from State 4 to State 2 and processors P1, P2 and P3 are inhibited from indicating bus requests until processor P1 completes the activities which gave rise to its bus request.

An event E15 occurs in State 4 occurs if processor P1 issues a bus ownership request at its BR0 terminal 10 when none of the processors P0, P2 and P3 are inhibited from indicating bus requests of that type. Arbiter 34 transitions to State 3 and processors P0, P2 and P3 are inhibited from indicating bus requests until processor P1 completes the activities that gave rise to its bus request.

Arbiter 34 remains in State 4 during event E16 if either processor P2 is making a bus request signal at its BR0 terminal 10 or none of the processor P0, P1 or P3 is making such a request. In such a case, arbiter 34 remains in State 4 until one of events E13, E14 or E15 should happen.

It can thus be seen that arbiter 34 behaves as a bus agent capable of arbitrating on behalf of all four processors P0, P1, P2 and P3 in a fair and rotating manner. The only requirement imposed on the external central arbiter 34 is that it be able to operate at the specified bus frequency and with no wait states to achieve the highest possible system performance. Additionally, as noted, software (BIOS) is provided to determine the number of processors or CPU's installed, initialize each such processor or CPU and assign unique identifier numbers or identifiers to those processors.

Although the invention has been described with reference to specific embodiments, this description is not meant to be construed in a limiting sense. Various modifications of the disclosed embodiment, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A data processing node having four processors operating off a common local interconnect, the node comprising:
each of said four processors being connected to the local interconnect and further having only two external arbitration lines; and
an arbiter connected to each of the two external arbitration lines of each of said four processors and arbitrating on behalf of said four processors for access to the local interconnect.

2. The data processing node of claim 1, wherein said arbiter includes:
Ad means for recognizing a bus ownership request from an arbitration line of one of the four processors connected to the arbiter.

3. The data processing node of claim 2, wherein said arbiter includes:
means for granting control of the local interconnect to the processor of the four processors recognized as originator of the bus ownership request.

4. The data processing node of claim 2, wherein said arbiter includes:
means for inhibiting bus ownership requests from the other of the four processors not recognized as originator of the bus request signal.

5. A method of operating a data processing node consisting of four processors off a common local interconnect, each processor having only two external arbitration lines, comprising the steps of:
furnishing signals from each of the two external arbitration lines to an arbiter; and
arbitrating on behalf of each of the four processors for access to the local interconnect.

6. The method of claim 5, wherein said step of arbitrating comprises the step of:
recognizing a bus ownership request from an arbitration line of one of the four processors connected to the arbiter.

7. The method of claim 6, wherein said step of arbitrating comprises the step of:
granting control of the local interconnect to the processor of the four processors recognized as originator of the bus ownership request.

8. The method of claim 6, wherein said step of arbitrating comprises the step of:
inhibiting bus ownership requests from the other of the four processors not recognized as originator of the bus request signal.

9. An arbiter for arbitrating for access to a local interconnect in a data processing system on behalf of four processors in the data processing system, each of the processors having only two external arbitration lines, said arbiter comprising:
means for recognizing a bus ownership request from an arbitration line of one of the four processors connected to the arbiter; and
means for granting control of the local interconnect to the processor of the four processors recognized as originator of the bus ownership request.

10. The arbiter of claim 9, wherein said arbiter further comprises:
means for inhibiting bus ownership requests from the other of the four processors not recognized as originator of the bus request signal.

11. A computer system including a plurality of nodes, at least one of said nodes having four processors operating off a common local interconnect comprising, the node comprising:
each of said four processors being connected to the local interconnect and further having only two external arbitration lines; and
an arbiter connected to each of the two external arbitration lines of each of said four processors and arbitrating on behalf of said four processors for access to the local interconnect.
